(19) United States
(12) Patent Application Publication
(10) Pub. No.: US 2026/0213228 A1
(43) Pub. Date: Jul. 23, 2026

(54) SOC STACK COMPRISING COMBINED FLOW DISTRIBUTOR AND CONTACT ENABLER

(71) Applicant: Topsoe A/S, Kgs. Lyngby (DK)

(72) Inventors: Thomas Heiredal-Clausen, Birkerød (DK); Jeppe Rass-Hansen, Copenhagen V (DK); Bengt Peter Gustav Blennow, Humlebæk (DK); Tobias Holt Nørby, Glostrup (DK)

(73) Assignee: Topsoe A/S, Kgs. Lyngby (DK)

(21) Appl. No.: 19/139,685

(22) PCT Filed: Dec. 15, 2023
(86) PCT No.: PCT/EP2023/086152

§ 371 Date: Jun. 16, 2025

(30) Foreign Application Priority Data
Dec. 20, 2022 (EP) 22214928.8
Apr. 19, 2023 (EP) 23168754.2

(51) Int. Cl. H01M 8/026; H01M 8/0206; H01M 8/12; H01M 8/2425

(52) U.S. Cl. CPC H01M 8/026; H01M 8/0206; H01M 8/12; H01M 8/2425; H01M 2008/1293

(57) ABSTRACT

A Solid Oxide Cell stack has a combined flow distributor and contact enabler made of pressed metal foil with flow guides and contact areas located between an interconnect layer and a cell layer in the stack.

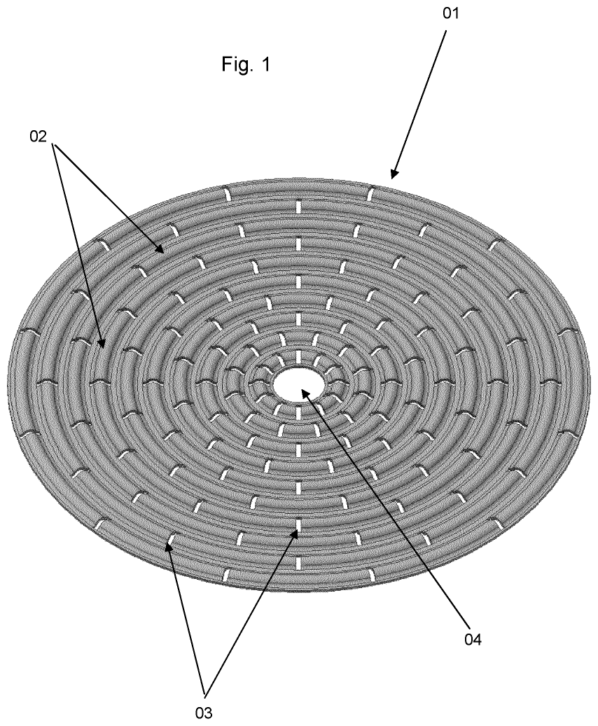

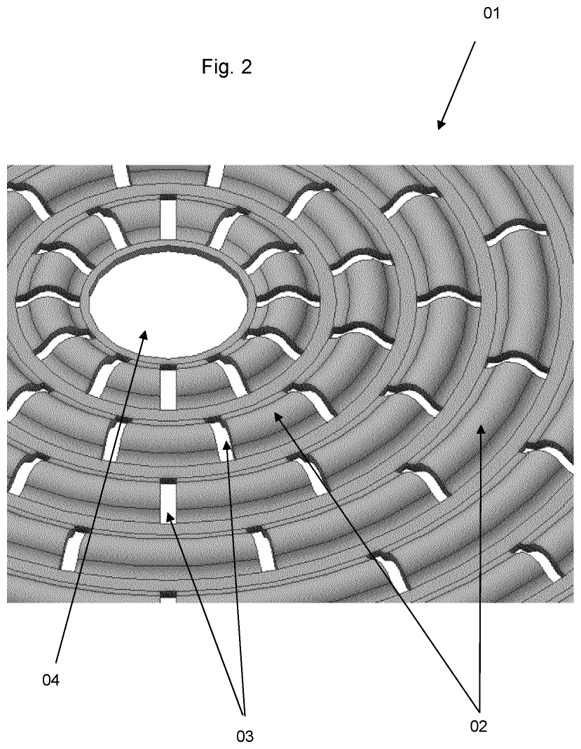

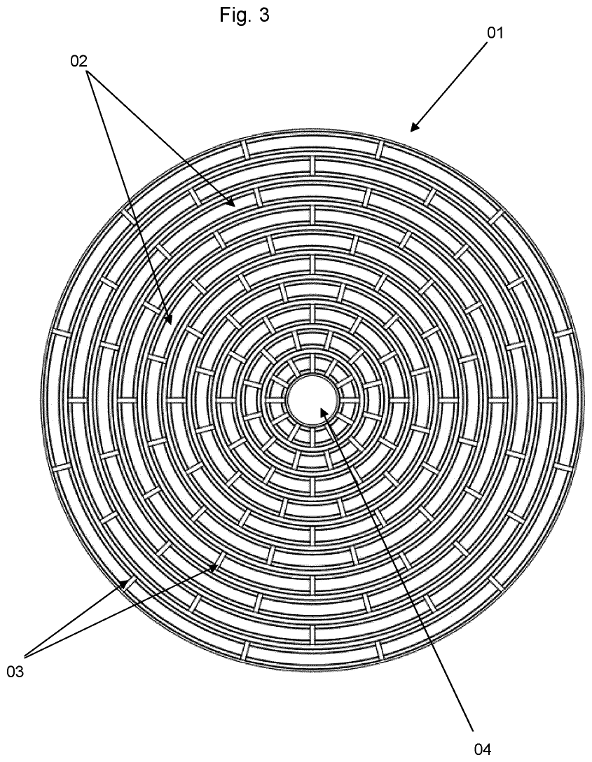

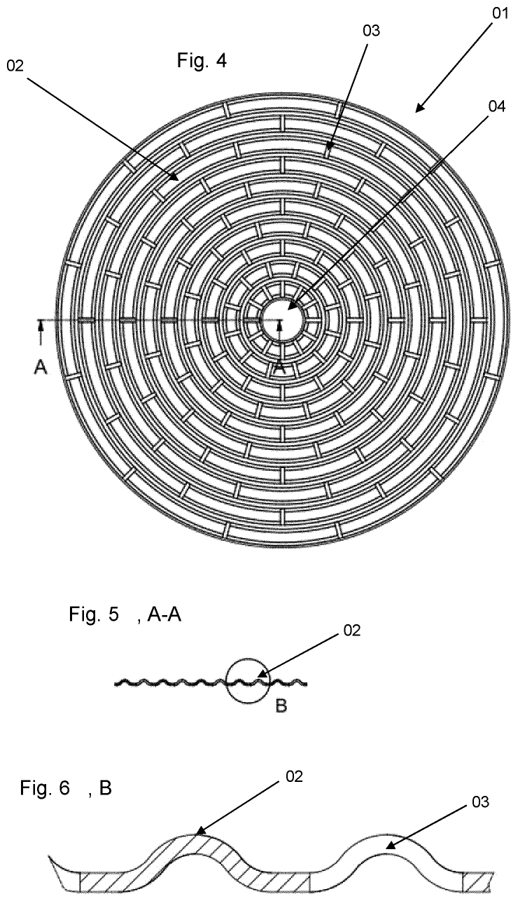

### FIELD OF THE INVENTION

The invention relates to a Solid Oxide Cell (SOC) stack, in particular a Solid Oxide Electrolysis Cell (SOEC) stack or a Solid Oxide Fuel Cell (SOFC) stack, comprising a plurality of elements which each are a combined flow distributor and contact enabler.

### BACKGROUND OF THE INVENTION

This invention can generally be used in a SOC stack—thus both in SOEC and SOFC mode even though for simplicity some parts of the description below relates to SOEC mode.

In SOC stacks which has an operating temperature between 600° C. and 1000° C., preferably between 600° C. and 850° C., several cell units are assembled to form the stack and are linked together by interconnects. Interconnects serve as a gas barrier to separate the anode and cathode sides of adjacent cell units, and at the same time they enable current conduction between the adjacent cells, i.e. between an anode of one cell and a cathode of a neighbouring cell. Further, interconnects are normally provided with a plurality of flow paths for the passage of process gas on both sides of the interconnect. To optimize the performance of a SOC stack, a range of positive values should be maximized without unacceptable consequence on another range of related negative values which should be minimized. Some of these values are:

| VALUES TO BE MAXIMIZED | VALUES TO BE MINIMIZED |
|---|---|
| Process gas utilization | Cost |
| electrical efficiency | Dimensions |
| lifetime | production time |
| | fail rate |
| | number of components |
| | Parasitic loss (heating, |
| | cooling, blowers . . .) |
| | material use |

Almost all the above listed values are interrelated, which means that altering one value will impact other values. Some relations between the characteristics of process gas flow in the cells and the above values are mentioned here:

### Process Gas Utilization:

The flow paths on the interconnect should be designed to seek an equal amount of process gas to each cell in a stack, i.e. there should be no flow—“short-cuts” through the stack.

### Parasitic Loss:

Design of the process gas flow paths in the SOC stack and its cell units should seek to achieve a low pressure loss per flow volume, which will reduce the parasitic loss to blowers.

### Electric Efficiency:

The interconnect leads current between the anode and the cathode layer of neighbouring cells. Hence, to reduce internal resistance, the electrically conducting contact points (hereafter merely called “contact points”) of the interconnect should be designed to establish good electrical contact to the electrodes (anode and cathode) and the contact points should no where be far apart, which would force the current to run through a longer distance of the electrode with resulting higher internal resistance.

### Lifetime:

It is desirable that the lifetime of an SOC stack is maximized, i.e. that in SOFC mode it can be used to produce as much electricity as possible and that in SOEC mode the amount of electrolysis product (e.g. H₂ and/or CO) is maximized. Stack lifetime depends on a number of factors, including the choice of the interconnect and spacer, on flow distribution on both process gas sides of the interconnect, evenly distributed protective coating on the materials, on the operating conditions (temperature, current density, voltage, etc), on cell design and materials, edge reoxidation which lowers the lifetime and many other factors.

### Cost:

The cost contribution of the interconnects (and spacers) can be reduced by not using noble materials, by reducing the production time of the interconnect and spacer, minimizing the number of components and by minimizing the material loss (the amount of material discarded during the production process.

### Dimensions:

The overall dimensions of a fuel stack are reduced, when the interconnect design ensures a high utilization of the active cell area. Dead-areas with low process gas flow should be reduced and inactive zones for sealing surfaces should be minimized.

### Production Time.

Production time of the interconnect and spacer itself should be minimized and the interconnect design should also contribute to a fast assembling of the entire stack. In general, for every component the interconnect design renders unnecessary, there is a gain in production time.

### Fail Rate.

The interconnect and spacer production methods and materials should permit a low interconnect fail rate (such as unwanted holes in the interconnect gas barrier, uneven material thickness or characteristics). Further the fail-rate of the assembled cell stack can be reduced when the interconnect design reduces the total number of components to be assembled and reduces the length and number of seal surfaces.

### Number of Components.

Apart from minimizing errors and assembling time as already mentioned, a reduction of the number of components leads to a reduced cost.

The way the anode and cathode gas flows are distributed in a SOC stack is by having a common manifold for each of the two process gasses. The manifolds can either be internal or external. The manifolds supply process gasses to the individual layers in the SOC stack by the means of channels to each layer. The channels are normally situated in one layer of the repeating elements which are comprised in the SOC stack, i.e. in the spacers or in the interconnect.

Interconnects and spacers which are made of sheet metal, are normally made of two separate parts of sheet material, which are sealed together in the SOC stack. This requires sealing between interconnect and spacer, plus handling of the separate components in the production. Furthermore, as the two separate sheet pieces often have the same outer dimensions, a lot of material, is wasted when most of the centre material of the spacer sheet is removed (e.g. stamped out).

Solid oxide electrolysis cells (SOEC) can be used to convert H2O to H2, CO2 to CO, or a combination of H2O and CO₂ to syngas (H2 and CO). This conversion occurs on the cathode side (fuel side) of the SOEC, where the cell comprises of Nickel containing layers in their reduced state. On the oxy side of the SOEC (the anode), oxygen is produced and is normally flushed with air.

When stacking the Solid Oxide Cells to an SOC stack, the cells are separated by interconnects that has several functionalities. The functionalities of the interconnect includes 1) to separate the gasses between the fuel and oxy side of the SOC, i.e. the fuel comprising H2O and/or CO2 on the fuel side and the oxy flow comprising Air and O2 on the oxy side of the SOC. 2) to distribute the flows of both gasses (fuel or oxy flow) on the active area of the SOC on their respectable sides. 3) to transport current from one cell to the next in the stack—from the fuel side of one cell to the oxy side of the adjacent cell. 4) to enable adequate electrical contact between the cell and the interconnect on both sides. 5) to support the SOC mechanically and 6) to ensure all the above, while accommodating for production tolerances of all components in the stack (cell, sealing material and the interconnect itself) i.e. the thickness and straightness tolerances of the components.

The interconnect thus holds a lot of functionalities, some of them counteracting and all of them with a large degree of interplay, which complicates the design and limits the design freedom. It is thus an advantage if some of the functionalities of the interconnect can be separated to other components to decrease the complexity of the interconnect design, yielding higher freedom of design and production- and material choices.

Contact enablers are commonly used between IC and cell to ensure good contact and to some extend to take up minor production tolerances. Especially on the fuel side of the cell interconnect, thin (<100 μm) meshes, foams or the like made of Nickel or other materials are commonly used to ensure good electrical contact by having a (slightly) deformable element between the cell layers comprising of Nickel and the interconnect. The Nickel meshes or foam can ensure a good electrical contact on the fuel side by taken some of the local or minor production tolerances.

Thus, using a contact enabler on the fuel side can be used to mitigate functionality 4) and to some extend 6) in the listed functionalities of the interconnect above. The use of for instance a Nickel contact enabling element on the fuel side is a good way of ensuring a good electrical contact, as the Nickel contact enabler can bond to the cell layer on the fuel side which comprises of Nickel by interdiffusion between the contact element and the cell. Similar the Nickel contact enabler can bond to the interconnect, typically made of high temperature ferritic stainless steel.

The invention aims to solve the problem of moving more of the functionalities from the interconnect to the contact enabling element on the fuel side by including contact enabling, flow distribution and uptake of production tolerances in the contact enabling element. Thus, the functionalities of the interconnect are reduced to that of a 1) gas separator, 2) flow distributor—only on the oxy side, 3) current conductor between the cells, 4) contact enabler—only on the oxy side and 5) support of cell—only on the oxy side.

U.S. Pat. No. 6,492,053 discloses a fuel cell stack including an interconnect and a spacer. Both, the interconnect and the spacer, have inlet and outlet manifolds for the flow of oxygen/fuel. The inlet and outlet manifolds have grooves/passages on its surface for the distribution of oxygen/fuel along the anode and cathode. However, the grooves/passages of the interconnect and spacer are not aligned with each other and hence their geometries could not be combined to achieve multiple inlet points. Also, since the grooves/passages are on the surface of both the interconnect and spacers, the formation of multiple inlet points are not feasible.

US2010297535 discloses a bipolar plate of a fuel cell with flow channels. The flow plate has multiple channels for distributing fluid uniformly between the active area of the fuel cell. The document does not describe a second layer and similar channels within it.

US2005016729 discloses a ceramic fuel cell(s) which is supported in a heat conductive interconnect plate, and a plurality of plates form a conductive heater named a stack. Connecting a plurality of stacks forms a stick of fuel cells. By connecting a plurality of stacks end to end, a string of fuel cells is formed. The length of the string can be one thousand feet or more, sized to penetrate an underground resource layer, for example of oil. A pre-heater brings the string to an operating temperature exceeding 700 DEG C., and then the fuel cells maintain that temperature via a plurality of conduits feeding the fuel cells fuel and an oxidant, and transferring exhaust gases to a planetary surface. A manifold can be used between the string and the planetary surface to continue the plurality of conduits and act as a heat exchanger between exhaust gases and oxidants/fuel.

None of the above described known art provides a simple, efficient solution to the above described problems.

Therefore, with reference to the above listed considerations, there is a need for a simple and easy but still robust, effective and precise solution to produce an SOC stack comprising a combined flow distributor and contact enabler.

These and other objects are achieved by the invention as described below.

### SUMMARY OF THE INVENTION

As described in the above, the standard solution is to have an interconnect with at least 6 functionalities, which can be reduced slightly by introducing contact enablers, that are commonly used between the fuel side of the interconnect and cell to ensure good contact and to some extend to take up minor/local production tolerances (roughness).

In one embodiment, the present invention is a novel contact enabler on for instance the fuel side of the stack between the cell and the interconnect in the form of a deep drawn (pressed) Nickel foil (or other material), that is much thicker (~500 μm) than the standard solution with Nickel mesh or foam (<100 μm).

The deep drawn Nickel foil is thick enough to accommodate fuel distribution channels, that ensures the flow distribution on the active area of the fuel side of the cell. The deep drawn Nickel foil will also ensure adequate electrical contact between cell and interconnect as the standard solutions, but as the foil is deformable when producing the stack and the foil can be pressed to a larger height that the finished geometry in the stack (+~100 μm)—the Nickel foil can also take up all production tolerances from all WO 2024/132%5 PCT/EP2023/086152 components when producing the stack, thus eliminating this functionality requirement from the interconnect.

Several functionalities of the interconnect are transferred to the novel deep drawn Nickel contact enabling foil. This reduces the complexity of the interconnect, which results in higher design freedom of the interconnect. The interconnect has no functionalities of the fuel side, as the Nickel foil handles flow distribution and contact and the interconnect design, material choice and fabrication methods can thus be optimized for the oxy side of the cell (and as gas separator).

The Nickel foil is compared to the standard contact enabling Nickel mesh or foam a more complex component, but as the Nickel foil only experience fuel side conditions it only has to be optimized for fuel side conditions with regards to flow distribution and contact. Thus, the extra functionalities of the contact enabling element (Nickel foil) comes at a marginal extra cost of the component.

In an embodiment, a great advantage of the novel contact and flow distributing element of the deep drawn Nickel foil is its ability to take up all production tolerances of all components used to build the stack (Cell, sealing material, interconnect and the Nickel foil itself). This is done by deep drawing the Nickel foil to a larger height than the final height in the stack—it is produced with an “overheight”. The overheight of the Nickel foil is used to accommodate for (even large) production tolerances of the stack components, while ensuring adequate contact and support to the cell on the fuel side as the stack is produced and the components of the stack is compressed together. The Nickel foil can be designed to creep during the production process of the stack, as the deep drawing can make a “creep-able” structure. Also, the fact that the Nickel foil on the fuel side is in a reducing environment ensures a high creep rate of Nickel compared with the interconnect and cell.

The ability of being able to take up large production tolerances of the stack components reduces the requirement of the components and production methods and thus comes with a cost reduction.

In an embodiment, using a Nickel foil as contact enabling element between cell and interconnect on the fuel side has the same contact enabling benefits as the standard contact enabler made of Nickel mesh or foam, as it can create a strong bond to the cell and the interconnect. But using the novel higher Nickel foil as contact enabler introduces a more flexible element to ensure contact between cell and interconnect in operation, where thermal expansions can interrupt the contact. As the Nickel foil can be well-bonded to the cell and the interconnect and on top of that is able to creep—the contact integrity can be maintained during operation, even with large thermal expansion differences between the layers (the Nickel foil acts as a bonded string between cell and IC, that allows for changes in distances between cell and interconnect arising from differences in thermal expansion of the components and temperature gradients in the stack).

The invention according to claim 1 is a Solid Oxide Cell stack comprising a plurality of stacked cell units as known in the art. Each cell unit comprises a cell layer with a solid oxide cell and an interconnect layer with an interconnect. As known, an interconnect layer separates one cell layer from an adjacent cell layer in the cell stack. Particular for this invention is that a cell unit in the stack also comprises at least one combined flow distributor and contact enabler made of pressed metal foil. This has the function of both providing flow patterns for process gas in a desired pattern and quantity as well as providing well defined, strong and reliable mechanical as well as electrical contact between the interconnect and the adjacent cell layer between which the combined flow distributor and contact enabler is located.

In an embodiment of the invention, the combined flow distributor and contact enabler is particularly located on a fuel side of the interconnect, which again faces a fuel side of an adjacent solid oxide cell in the solid oxide cell stack. The flow guide and contact areas of the combined flow distributor and contact enabler may have specified dimensions which is possible because the combined flow distributor and contact enabler is made from pressed metal foil as opposed to for instance a contact enabler made from a more undefined mesh. The metal foil may have protrusions pressed to an exact specified dimension (thickness of the combined flow distributor and contact enabler) or even to an exact specified over-dimension, which is then pressed to its final dimension when the stack is assembled and put under a compression force. Likewise, the flow guides and contact areas of the combined flow distributor and contact enabler may be located with specified distances to each other and in specified patterns, which is again possible because it is made of a metal foil pressed according to a specified pattern or mould, contrary to for instance a metal mesh which may be more chaotic or erratic in its appearance and structure.

In an embodiment of the invention, each of the combined flow distributor and contact enabler has a contact area, the area of the combined flow distributor and contact enabler, which is in physical, mechanical contact with the adjacent solid oxide cell which is between 2% and 50% of the total area of the adjacent solid oxide cell. The combined flow guides and contact areas may be pressed elongate and wave shaped protrusions in the metal foil and they may be located and oriented to provide an alternating flow path. In an embodiment, the combined flow guides and contact areas are pressed, elongate, straight and wave shaped protrusions in the metal foil, where each protrusion has contact to the metal foil on only one side of the wave. In another embodiment, the wave shaped protrusions may be curved.

In an embodiment, the metal foil may be pressed, without moving material from the foil, whereas in another embodiment, material may be removed from the metal foil, and in a further embodiment the removed material may provide guides for the pressing of the metal foil. Further, the areas with removed material from the metal foil may provide flow paths through the combined flow distributor and contact enabler. Prior the pressing of the metal foil, it may be laser cut, etched, waterjet cut (or micro abrasive waterjet cut) or stamped, whatever process suits the purpose of producing the combined flow distributor and contact enabler best. The production process of the combined flow distributor and contact enabler may also involve to simultaneously pressing and cutting the metal foil.

In an embodiment of the invention, as also described and explained in the above, the metal foil is made of nickel or at least coated with nickel. The thickness of the metal foil used to produce the combined flow distributor and contact enabler may be between 50 μm and 1200 μm, preferably between 100 μm and 300 μm. Whereas the height of said combined flow distributor and contact enabler after the metal foil of said combined flow distributor and contact enabler has been pressed is between 200 μm and 3000 μm, preferably between 400 μm and 1000 μm. Hence, because of the pressed protrusions in the metal foil, the combined flow distributor and contact enabler after it has been pressed has a larger height than the thickness of the metal foil itself.

As also mentioned in the above, the combined flow distributor and contact enabler may be produced to an “over”-thickness before assembly in the solid oxide cell stack. Hence, the height of said combined flow distributor and contact enabler before assembly between the interconnect and the solid oxide cell is between 20 μm and 1000 μm, preferably between 50 μm and 200 μm larger than the height of said combined flow distributor and contact enabler when located within the solid oxide cell stack after finished production of said solid oxide cell stack. Accordingly, after production of the solid oxide cell stack, which may involve pressing forces and raised temperatures, the height of the combined flow distributor and contact enabler is reduced while providing good mechanical and electrical contact to the interconnect and the adjacent cell unit.

Accordingly, in an embodiment of the invention, the combined flow distributor and contact enabler is connected to the solid oxide cell by diffusion bonding on at least a part of the surface of the combined flow distributor and contact enabler facing the solid oxide cell.

In an embodiment of the invention, a well-defined orientation and location of the combined flow distributor and contact enabler relative to at least its adjacent interconnect is secured by at least one fixation guide adapted to interact with the interconnect to provide a specific position of the combined flow distributor and contact enabler relative to the interconnect. The fixation guide may be made by a bent part, an at least partly stamped and bent part of the combined flow distributor and contact enabler, or material positioned by point welding or laser welding.

In an embodiment of the invention at least a majority of the surface of said interconnect facing said combined flow distributor and contact enabler is even and without protruding flow guides and contact areas. And in a further embodiment of the invention the Solid Oxide Cell stack is a Solid Oxide Electrolysis Cell stack.

### Features of the Invention

1. Solid oxide cell stack comprising a plurality of stacked cell units, each cell unit comprises a cell layer comprising a solid oxide cell and an interconnect layer comprising an interconnect, one interconnect layer separates one cell layer from the adjacent cell layer in the cell stack, wherein the cell unit further comprises at least one combined flow distributor and contact enabler made of pressed metal foil and comprising combined flow guides and contact areas, the combined flow distributor and contact enabler is located between said interconnect layer and said cell layer and provides physical and electrical contact between said interconnect layer and said cell layer.
2. Solid oxide cell stack according to feature 1, wherein said combined flow distributor and contact enabler is located on a fuel side of the interconnect which faces a fuel side of an adjacent solid oxide cell in said solid oxide cell stack.
3. Solid oxide cell stack according to any of the preceding features, wherein said combined flow guides and contact areas have specified dimensions.
4. Solid oxide cell stack according to any of the preceding feature, wherein said combined flow guides and contact areas are located with specified distances and in a specified pattern.
5. Solid oxide cell stack according to any of the preceding features, wherein said each of said combined flow distributor and contact enabler has a contact area to the adjacent solid oxide cell which is between 2% and 50% of the total area of said adjacent solid oxide cell.
6. Solid oxide cell stack according to any of the preceding features, wherein said combined flow guides and contact areas are located in a pattern adapted to provide an alternating flow path.
7. Solid oxide cell stack according to any of the preceding features, wherein said combined flow guides and contact areas are pressed, elongate and wave shaped protrusions in said metal foil.
8. Solid oxide cell stack according to any of the preceding features, wherein said combined flow guides and contact areas are pressed, elongate, straight and wave shaped protrusions in said metal foil.
9. Solid oxide cell stack according to any of the preceding features, wherein said combined flow guides and contact areas are pressed, elongate, straight and wave shaped protrusions in said metal foil, wherein each protrusion has contact to the metal foil on only one side of the wave.
10. Solid oxide cell stack according to any of the preceding features, wherein said combined flow guides and contact areas are pressed, elongate, curved and wave shaped protrusions in said metal foil.
11. Solid oxide cell stack according to any of the preceding features, wherein said pressed metal foil comprises areas of the metal foil where metal foil material is removed.
12. Solid oxide cell stack according to feature 11, wherein said removed metal foil material provides guides for the pressing of said metal foil.
13. Solid oxide cell stack according to feature 11 or 12, wherein said removed metal foil material provides flow paths through said combined flow distributor and contact enabler.
14. Solid oxide cell stack according to any of the preceding features, wherein said metal foil is laser cut or etched or waterjet cut and/or micro abrasive waterjet cut or stamped prior to said pressing.
15. Solid oxide cell stack according to any of the preceding features, wherein said metal foil is simultaneously pressed and cut.
16. Solid oxide cell stack according to any of the preceding features, wherein said metal foil is made of nickel.
17. Solid oxide cell stack according to any of the preceding features, wherein said metal foil is coated with nickel.
18. Solid oxide cell stack according to any of the preceding features, wherein said metal foil thickness is between 50 μm and 1200 μm, preferably between 100 μm and 300 μm.
19. Solid oxide cell stack according to any of the preceding features, wherein the height of said combined flow distributor and contact enabler after the metal foil of said combined flow distributor and contact enabler has been pressed is between 200 μm and 3000 μm, preferably between 400 μm and 1000 μm.
20. Solid oxide cell stack according to any of the preceding features, wherein the height of said combined flow distributor and contact enabler before assembly between the interconnect and the solid oxide cell is between 20 μm and 1000 μm, preferably between 50 μm and 200 μm larger than the height of said combined flow distributor and contact enabler when located within the solid oxide cell stack after finished production of said solid oxide cell stack.
21. Solid oxide cell stack according to any of the preceding features, wherein said combined flow distributor and contact enabler is connected to the interconnect by diffusion bonding on at least a part of the surface of the combined flow distributor and contact enabler facing the interconnect.
22. Solid oxide cell stack according to any of the preceding features, wherein said combined flow distributor and contact enabler is connected to the solid oxide cell by diffusion bonding on at least a part of the surface of the combined flow distributor and contact enabler facing the solid oxide cell.
23. Solid oxide cell stack according to any of the preceding features, wherein said combined flow distributor and contact enabler comprises at least one fixation guide adapted to interact with the interconnect to provide a specific position of the combined flow distributor and contact enabler relative to the interconnect.
24. Solid oxide cell stack according to feature 23, wherein said at least one fixation guide is made by a bent part, an at least partly stamped and bent part of the combined flow distributor and contact enabler, or material positioned by point welding or laser welding.
25. Solid oxide cell stack according to any of the preceding features, wherein at least a majority of the surface of said interconnect facing said combined flow distributor and contact enabler is even and without protruding flow guides and contact areas.
26. Solid Oxide Cell stack according to any of the preceding features, wherein the Solid Oxide Cell stack is a Solid Oxide Electrolysis Cell stack.

1. Solid oxide cell stack comprising a plurality of stacked cell units, each cell unit comprises a cell layer comprising a solid oxide cell and an interconnect layer comprising an interconnect, one interconnect layer separates one cell layer from the adjacent cell layer in the cell stack, wherein the cell unit further comprises at least one combined flow distributor and contact enabler made of pressed metal foil and comprising combined flow guides and contact areas, the combined flow distributor and contact enabler is located between said interconnect layer and said cell layer and provides physical and electrical contact between said interconnect layer and said cell layer.

2. Solid oxide cell stack according to claim 1, wherein said combined flow distributor and contact enabler is located on a fuel side of the interconnect which faces a fuel side of an adjacent solid oxide cell in said solid oxide cell stack.

3. Solid oxide cell stack according to claim 1, wherein said combined flow guides and contact areas have specified dimensions.

4. Solid oxide cell stack according to claim 1, wherein said combined flow guides and contact areas are located with specified distances and in a specified pattern.

5. Solid oxide cell stack according to claim 1, wherein said each of said combined flow distributor and contact enabler has a contact area to the adjacent solid oxide cell which is between 2% and 50% of the total area of said adjacent solid oxide cell.

6. Solid oxide cell stack according to claim 1, wherein said combined flow guides and contact areas are located in a pattern adapted to provide an alternating flow path.

7. Solid oxide cell stack according to claim 1, wherein said combined flow guides and contact areas are pressed, elongate and wave shaped protrusions in said metal foil.

8. Solid oxide cell stack according to claim 1, wherein said combined flow guides and contact areas are pressed, elongate, straight and wave shaped protrusions in said metal foil.

9. Solid oxide cell stack according to claim 1, wherein said combined flow guides and contact areas are pressed, elongate, straight and wave shaped protrusions in said metal foil, wherein each protrusion has contact to the metal foil on only one side of the wave.

10. Solid oxide cell stack according to claim 1, wherein said combined flow guides and contact areas are pressed, elongate, curved and wave shaped protrusions in said metal foil.

11. Solid oxide cell stack according to claim 1, wherein said pressed metal foil comprises areas of the metal foil where metal foil material is removed.

12. Solid oxide cell stack according to claim 11, wherein said removed metal foil material provides guides for the pressing of said metal foil.

13. Solid oxide cell stack according to claim 11, wherein said removed metal foil material provides flow paths through said combined flow distributor and contact enabler.

14. Solid oxide cell stack according to claim 1, wherein said metal foil is laser cut or etched or waterjet cut and/or micro abrasive waterjet cut or stamped prior to said pressing.

15. Solid oxide cell stack according to claim 1, wherein said metal foil is simultaneously pressed and cut.

16. Solid oxide cell stack according to claim 1, wherein said metal foil is made of nickel.

17. Solid oxide cell stack according to claim 1, wherein said metal foil is coated with nickel.

18. Solid oxide cell stack according to claim 1, wherein said metal foil thickness is between 50 μm and 1200 μm.

19. Solid oxide cell stack according to claim 1, wherein the height of said combined flow distributor and contact enabler after the metal foil of said combined flow distributor and contact enabler has been pressed is between 200 μm and 3000 μm.

20. Solid oxide cell stack according to claim 1, wherein the height of said combined flow distributor and contact enabler before assembly between the interconnect and the solid oxide cell is between 20 μm and 1000 μm larger than the height of said combined flow distributor and contact enabler when located within the solid oxide cell stack after finished production of said solid oxide cell stack.

21. Solid oxide cell stack according to claim 1, wherein said combined flow distributor and contact enabler is connected to the interconnect by diffusion bonding on at least a part of the surface of the combined flow distributor and contact enabler facing the interconnect.

22. Solid oxide cell stack according to claim 1, wherein said combined flow distributor and contact enabler is connected to the solid oxide cell by diffusion bonding on at least a part of the surface of the combined flow distributor and contact enabler facing the solid oxide cell.

23. Solid oxide cell stack according to claim 1, wherein said combined flow distributor and contact enabler comprises at least one fixation guide adapted to interact with the interconnect to provide a specific position of the combined flow distributor and contact enabler relative to the interconnect.

24. Solid oxide cell stack according to claim 23, wherein said at least one fixation guide is made by a bent part, an at least partly stamped and bent part of the combined flow distributor and contact enabler, or material positioned by point welding or laser welding.

25. Solid oxide cell stack according to claim 1, wherein at least a majority of the surface of said interconnect facing said combined flow distributor and contact enabler is even and without protruding flow guides and contact areas.

26. Solid Oxide Cell stack according to claim 1, wherein the Solid Oxide Cell stack is a Solid Oxide Electrolysis Cell stack.
